(19) United States
(12) Patent Application Publication
(10) Pub. No.: US 2019/0226505 A1
(43) Pub. Date: Jul. 25, 2019

(54) HYDROSTATIC ACTUATOR WITH A SPLIT DYNAMIC SEAL PORTION

(71) Applicant: Schaeffler Technologies AG & Co. KG, Herzogenaurach (DE)

(72) Inventor: Matthias Ehrlich, Bühl (DE)

(73) Assignee: Schaeffler Technologies AG & Co. KG, Herzogenaurach (DE)

(21) Appl. No.: 16/333,616

(22) PCT Filed: Oct. 5, 2017
(86) PCT No.: PCT/DE2017/100847

§ 371 Date: Mar. 15, 2019

(30) Foreign Application Priority Data
Oct. 7, 2016 (DE) 10 2016 219 443.7

(51) Int. Cl. F15B 15/14; F16D 25/08; F16J 9/12

(52) U.S. Cl. CPC F15B 15/1452; F16J 9/12; F16D 25/08

(57) ABSTRACT

A hydrostatic actuator for a motor vehicle includes a housing, a piston, and a seal. The piston has a lateral surface and is arranged within the housing in a longitudinally movable manner. The seal is inserted between the lateral surface and the housing in a fluid-tight manner. The seal has a securing region that rests in a statically sealing manner against a one of the housing or the piston, and a sealing lip region. The sealing lip region includes a first sealing lip for dynamically sealing to the other one of the housing or the piston when pressure in an external space is greater than pressure in an internal space, and a second sealing lip for dynamically sealing to the other one of the housing or the piston when pressure in an external space is less than pressure in an internal space.

### CROSS-REFERENCE TO RELATED APPLICATIONS

This application is the United States National Phase of PCT Appln. No. PCT/DE2017/100847 filed Oct. 5, 2017, which claims priority to German Application No. DE102016219443.7 filed Oct. 7, 2016, the entire disclosures of which are incorporated by reference herein.

### TECHNICAL FIELD

The disclosure relates to a hydrostatic actuator for a motor vehicle assembly, having a piston, which is arranged within a housing in a longitudinally movable manner. A seal is inserted between the lateral surface of the piston and the housing in a fluid-tight manner. The seal has a securing region, in which it rests in a statically sealing manner against the housing or the piston or is inserted/secured, and a sealing lip region, in which it rests in a dynamically sealing manner against the piston that can be shifted/moved relative to the securing region or against the housing. Hydrostatic actuators of this kind are used, for example, to actuate clutches or brakes and have the advantage that high forces can be transmitted by said actuators in the case of a flexible force transmission path by the at least approximately incompressible hydraulic fluid.

### BACKGROUND

Hydrostatic actuators are known from the prior art. Thus, German Patent Application DE 10 2015 201596 A1 discloses a master cylinder of a pressure medium actuating device for a hydraulic clutch or brake, having a cylinder and a piston arranged movably therein. At least one seal arrangement is provided between a piston wall and a cylinder wall to ensure sealing between the piston and the cylinder. For this purpose, use is made of annular seals, which are inserted into an annular groove in a wall of the piston or of the cylinder and which, during the operation of the master cylinder, are supported in a sealing manner both on a wall of the piston and a wall of the cylinder. For this purpose, the seal has a static sealing lip, which exhibits no movement relative to its seat or its contact surface, and a dynamic sealing lip, which is designed for sliding contact with a contact surface.

As is known, the sealing properties of a seal are largely dependent on the temperature, since the flexibility which enables the dynamic sealing lip, in particular, to be pressed into contact decreases as the temperature falls.

In order to achieve reliable sealing, even at low temperatures, the prior art, particularly in the form of the abovementioned document, discloses a seal which has a heating element. This is designed to guarantee a minimum temperature in the region of the seal at all times during operation, said minimum temperature being above the temperature at which the flexibility of the sealing lip decreases to such an extent that reliable sealing is no longer guaranteed.

One disadvantage of this prior art is that the additional heating element has to be connected to an electric circuit in order to supply heat. This entails additional connections, which increase the complexity of the unit. A heating element of this kind is furthermore disadvantageous in terms of thermal efficiency since an additional amount of energy has then to be produced. Another disadvantage of the prior art is the reliability of the device. As soon as the heating element or a connecting line is faulty, it is no longer possible to guarantee a leaktight fluid space.

### SUMMARY

According to the disclosure, the sealing lip region has two sealing lips, one of which is provided for contacting the surface of the piston that can be moved relative to the securing region or of the housing in the event of positive pressure, and the other of which contacts same in the event of negative pressure for dynamic sealing purposes. In this way, a reliable sealing function is guaranteed, irrespective of the operating state, even at very low temperatures measured in relation to normal ambient conditions. The division of the sealing lip region into at least two portions likewise allows individually tailored geometry of the respective sealing lip. Depending on the use, the sealing lip region can thus be adapted to the available installation space, increasing the flexibility of the actuator according to the disclosure.

Thus, it is advantageous if the two sealing lips point in different directions. This ensures that a first sealing lip assumes the clearly assigned task of sealing between an external space and an interspace defined by the two sealing lips, while a second sealing lip assumes the clearly defined task of sealing between an internal space and the interspace. Thus, a strict separation is made between the function of the individual sealing lips. This facilitates the process of designing the ideally tailored seal. Alignment in different directions furthermore allows contact between the sealing lips and the piston at an angle such that a high degree of sealing is achieved.

In an example embodiment, both sealing lips are aligned transversely to the longitudinal direction of the piston and transversely to the radial direction of the piston, and they preferably define two angles of equal magnitude relative to a radial plane. The arrangement of the first and second sealing lip relative to each other, which is thus symmetrical, has a positive effect on the economy of manufacture of the seal.

As soon as the seal has at least four surfaces in the seal region, high reliability in the degree of sealing is achieved. In this case, the first sealing lip and the second sealing lip each form two surfaces. Overall, the four surfaces can be divided into an external-space surface, a first interspace surface, i.e., the surface of the first sealing lip which points in the direction of the interspace, a second interspace surface, i.e., the surface of the second sealing lip which points in the direction of the interspace, and an internal-space surface. Each one of these surfaces can be tailored to the respectively prevailing conditions. If, for example, the pressure difference between the internal space and the interspace is greater than the difference between the external space and the interspace, then, irrespective of the operating state, the respective surfaces can be tailored flexibly to this state.

It is likewise advantageous if the preferably empty interspace is formed between the sealing lips. This interspace is defined by the sealing lip region of the seal and the piston and has no channel leading to fluid exchange with some other volume. The pressure in the interspace should preferably be kept to such a low level that both the pressure of the internal space and that of the external space exceeds that of the internal space. Thus, contact pressure on the respective sealing lips is guaranteed.

Thus, it can be stated that it is advantageous if the sealing lips are matched to the piston in such a way that the pressure in the interspace is lower than outside the interspace. Thus, liftoff of the respective sealing lip is avoided, even at low temperatures, and continuously high sealing quality is guaranteed.

If both sealing lips rest at an acute angle on the lateral surface of the piston, the structure achieved is furthermore such that it is made more difficult for the sealing lips to be folded over by the geometry. Here, the angle described is the angle between the interspace surface of the respective sealing lip and the piston against which the seal rests. The corresponding opposite angle between the external-space surface and the piston, or between the internal-space surface and the piston, is accordingly an obtuse angle since the piston is designed as a straight cylinder.

Since the seal is made of flexible material, preferably a material which gives rise to a preload, e.g. a uniform material, additional advantages are achieved. In this way, on the one hand, economical manufacture is obtained and, on the other hand, the seal according to the disclosure is thus capable of compensating relatively small tolerances.

An example embodiment is furthermore characterized in that the hydrostatic actuator is designed as a hydrostatic clutch actuator (HCA for short). This standard component in drive trains can thus be replaced by the clutch actuator according to the disclosure, thereby making it possible to increase the operating reliability of drive trains since just one module is exchanged.

According to the disclosure, advantage also results in another embodiment if sealing lips have a self-reinforcing effect. Here, the term “self-acting” is taken to mean that the force with which one sealing lip rests against the piston is proportional to the pressure difference between the individual volumes. Thus, as the pressure difference between the spaces to be sealed off by the seal rises, a higher sealing force is entailed, thereby enhancing general operating reliability by minimizing a leakage risk.

In other words, it can be stated that the disclosure is directed to hydrostatic (clutch) actuators with seal systems. In this context, the geometry of the sealing lip region is shaped in such a way that self-reinforcement of the respective sealing lip is achieved both with respect to the external space and to the internal space in changing pressure conditions. Thus, any dependence on the static self-reinforcement of a seal is very largely eliminated.

Thus, the actuator according to the disclosure ensures that the negative pressure stability of the seal is improved, making the sealing function more robust in relation to low temperatures since the seal is of double-acting design.

According to the disclosure, the first sealing lip accordingly takes effect especially when the second sealing lip with the second dynamic sealing geometry has reached its elastic prestress limit. Thus, the second sealing lip no longer has to be designed for the case of negative pressure. Hence, a robust, reliable and economical seal for the hydrostatic actuator is obtained with only an insignificant additional installation space requirement as compared with seals known from the prior art.

Thus, in summary, it can be stated that the problem of the dependence of the seal quality on the temperature is precluded. For this purpose, a seal that has a plurality of dynamic surfaces with a self-reinforcing action is disclosed.

The seal thus has four dynamic sealing surfaces in the sealing lip region, thereby defining the interspace, which always has a lower pressure than the internal or external space. According to the disclosure, the sealing surfaces extend obliquely to the interspace and, with the latter, therefore form an acute angle with the piston surface. Thus, the seal is self-closing, even without elastic prestress.

### BRIEF DESCRIPTION OF THE DRAWINGS

The disclosure will now be explained in greater detail below by means of figures, of which:

FIG. 1 shows a schematic view of the actuator and of a seal; and

FIG. 2 shows the seal according to the disclosure with a first sealing lip and a second sealing lip.

The figures are of a purely schematic nature and serve only to aid understanding of the disclosure. The individual reference signs are interchangeable.

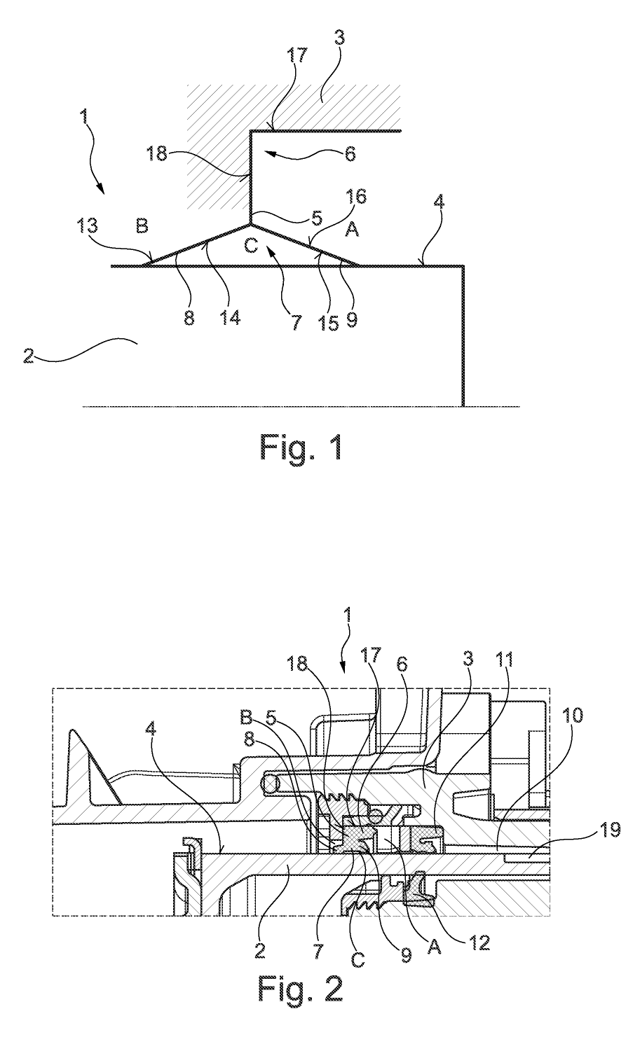

FIG. 1 shows a schematic view of a hydrostatic actuator 1 according to the disclosure. This actuator has a piston 2 arranged around a rotational axis in a longitudinally movable manner within a housing 3. The housing may be mounted in a fixed manner on an engine (not shown), for example. The piston 2 has a radially outward-facing lateral surface 4, which has surface characteristics such that a seal 5 can rest against it effectively and in a fully sealing manner. The seal 5 can be divided into a securing region 6 and a sealing lip region 7. The securing region 6 is designed as a static seal since it does not perform any movement relative to the housing 3. In contrast, the sealing lip region 7 is of dynamic configuration since the piston 2 is longitudinally movable and there is therefore a relative movement between the sealing lip region 7 and the piston 2.

In order to allow effective sealing, even in changing pressure conditions, the sealing lip region 7 is configured in such a way that it forms a first sealing lip 8 and a second sealing lip 9. The first sealing lip 8 is arranged between an external space B and an interspace C. An external-space surface 13 forms the boundary between the external space B and the first sealing lip 8. It is configured in such a way that it is optimized for sealing these volumes. A first interspace surface 14 is formed by the other side of the first sealing lip 8 and thus faces in the direction of the interspace C. Here, the pressure in the interspace C is preferably lower than the pressure in the external space B in every operating state.

Similarly to the first sealing lip 8, the second sealing lip 9 also has an outer surface and an inner surface. The inner surface, also referred to as the second interspace surface 15, faces in the direction of the interspace C, while the outer surface, also referred to as the internal-space surface 16, faces in the direction of an internal space A. In terms of their roughness and flexibility, the four surfaces 13, 14, 15, 16 are such as to allow fluid-tight sealing between the piston 2 and the internal space A, the interspace C and the external space B. Owing to the alignments of the two sealing lips 8, 9 in substantially opposite directions, the seal 5 is, according to the disclosure, self-reinforcing, irrespective of whether there is a higher pressure prevailing in the internal space A or the external space B.

Contact of the securing region 6 on or in the housing 3 is made via two contact surfaces. The height of the seal 5 in the radial direction is determined by means of a radial stop 17, while the axial position of the seal is fixed by means of an axial stop 18.

FIG. 2 illustrates another embodiment of the hydrostatic actuator 1 according to the disclosure. Here, the illustration of the seal 5 is based on another embodiment. The piston or cylinder 2 is embodied as a hollow cylinder, and the housing 3 is configured, for instance, as a casting, the shape of which is flexible. The seal 5 with the securing region 6 and the sealing lip region 7 is arranged between the housing 3 and the piston 2. Here, the ratio of the intermediate volume C to volumes A and B is less than one. Owing to the substantially equal angle of the first sealing lip 8 as it runs on the piston 2 to that of the second sealing lip 9 as it runs on the piston 2, self-reinforcement of the seal 5 is achieved here too since a pressure increase both in the internal space A and in the external space B leads to reinforcement of the sealing force.

A second seal 11 is arranged so as to extend further in the direction of the internal space 8 from seal 5. This second seal divides the internal volume A from a fluid space 10. The second seal 11 thus serves for increased reliability and robustness of the overall seal system. A third seal 12 is arranged radially to the inside of seal 5 and of the second seal 11. The second seal 11 and the third seal 12 likewise have a securing region and a sealing lip region, but these do not have a first sealing lip or a second sealing lip, as is the case with seal 5. Here too, the radial stop 17 performs the function of determining the position or centering the seal 5, as does the axial stop 18.

It may also be stated by way of explanation that the seal 11 can be undercut by a bypass 19 in a certain operating state. In this state, the intention is to balance out fluid, particularly air, i.e., to pass said fluid to a reservoir (not shown).

Thus, while guaranteeing high dynamism, the hydrostatic actuator 1 according to the disclosure is capable of performing effective sealing between the internal space A and the external space B since a slight negative pressure in the interspace C in comparison with spaces A and B is ensured.

### REFERENCE LABELS

1 hydrostatic actuator
2 piston
3 housing
4 lateral surface
5 seal
6 securing region
7 sealing lip region
8 first sealing lip
9 second sealing lip
10 fluid space
11 second seal
12 third seal
13 external-space surface
14 first interspace surface
15 second interspace surface
16 internal-space surface
17 radial stop
18 axial stop
19 bypass
A internal space
B external space
C interspace

1.-10. (canceled)

11. A hydrostatic actuator for a motor vehicle comprising:
a housing;
a piston comprising a lateral surface and arranged within the housing in a longitudinally movable manner; and,
a seal, inserted between the lateral surface and the housing in a fluid-tight manner, comprising:
a securing region that rests in a statically sealing manner against a one of the housing or the piston; and,
a sealing lip region comprising:
a first sealing lip for dynamically sealing to the other one of the housing or the piston when pressure in an external space is greater than pressure in an internal space; and,
a second sealing lip for dynamically sealing to the other one of the housing or the piston when pressure in an external space is less than pressure in an internal space.

12. The hydrostatic actuator of claim 11, wherein the first sealing lip and the second sealing lip extend in different directions.

13. The hydrostatic actuator of claim 11, wherein the first sealing lip and the second sealing lip are aligned transversely to a longitudinal direction of the piston and transversely to a radial direction of the piston.

14. The hydrostatic actuator of claim 11, wherein the seal comprises at least four surfaces in the sealing lip region.

15. The hydrostatic actuator of claim 11, wherein an interspace is formed between the first sealing lip and the second sealing lip.

16. The hydrostatic actuator of claim 15, wherein the first sealing lip and the second sealing lip are matched to the piston in such a way that the pressure in the interspace is lower than outside the interspace.

17. The hydrostatic actuator of claim 11, wherein the first sealing lip and the second sealing lip each rest at an acute angle on the lateral surface of the piston.

18. The hydrostatic actuator of claim 11, wherein the seal is constructed from a flexible material.

19. The hydrostatic actuator of claim 11, wherein the hydrostatic actuator is designed as a hydrostatic clutch actuator.

20. The hydrostatic actuator of claim 11, wherein the first sealing lip and the second sealing lip have a self-reinforcing effect.

21. An annular seal for a hydrostatic actuator comprising:
a securing region comprising a radially extending surface and a circumferentially extending surface; and,
a sealing lip region extending from the securing region and comprising a first sealing lip extending at least partially in a first axial direction and a second sealing lip extending at least partially in a second axial direction, opposite the first axial direction.

22. A hydrostatic actuator comprising:
a housing comprising a radial stop and an axial stop;
a piston comprising a radially outward facing lateral surface; and,
the annular seal of claim 21, wherein:
the securing region contacts the radial stop and the axial stop; and,
the sealing lip region contacts the radially outward facing lateral surface.

23. The hydrostatic actuator of claim 22 wherein the securing region forms a static seal to the housing and the sealing lip region forms a dynamic seal to the piston.

24. The hydrostatic actuator of claim 22 wherein the piston is at least partially formed by a hollow cylinder.

25. The hydrostatic actuator of claim 22 further comprising a second seal contacting the housing and the piston.

26. The hydrostatic actuator of claim 25 further comprising a third seal contacting the piston.

27. The hydrostatic actuator of claim 22 further comprising an interspace disposed axially between the first sealing lip and the second sealing lip.

28. The hydrostatic actuator of claim 27 wherein the interspace is at least partially bounded by the radially outward facing lateral surface.

29. The hydrostatic actuator of claim 27 wherein:
the first sealing lip comprises first and second surfaces;
the second sealing lip comprises third and fourth surfaces; and,
the interspace is at least partially bounded by the second and third surfaces.

30. The hydrostatic actuator of claim 29 further comprising:
an external space at least partially bounded by the first surface; and,
an internal space at least partially bounded by the fourth surface.
